(19) United States
(12) Patent Application Publication
(10) Pub. No.: US 2016/0234176 A1
(43) Pub. Date: Aug. 11, 2016

(54) ELECTRONIC DEVICE AND DATA TRANSMISSION METHOD THEREOF

(71) Applicant: SAMSUNG ELECTRONICS CO., LTD., Suwon-si (KR)

(72) Inventors: YOUNSUNG CHU, HWASEONG-SI (KR); YUSEOP LEE, SEOUL (KR)

(21) Appl. No.: 15/016,447

(22) Filed: Feb. 5, 2016

Related U.S. Application Data
(60) Provisional application No. 62/112,671, filed on Feb. 6, 2015.

(30) Foreign Application Priority Data
Apr. 14, 2015 (KR) 10-2015-0052549

(51) Int. Cl. H04L 29/06; H04L 9/32; G06F 21/62; G06F 21/60

(52) U.S. Cl. CPC H04L 63/0428; H04L 63/083; G06F 21/602; G06F 21/606; H04L 63/061; H04L 9/3247; H04L 9/3242; G06F 21/6245

(57) ABSTRACT

A data transmission method of an electronic device having a secure element includes executing a trusted application on a trusted execution environment; taking an ownership with respect to the secure element using a personal identification number in the trusted execution environment; collecting data related to personal information of a user, after obtaining the ownership; encrypting the data in the secure element; and outputting the encrypted data to an external server.

### CROSS-REFERENCE TO RELATED APPLICATIONS

A claim for priority under 35 U.S.C. §119 is made to U.S. Provisional Patent Application No. 62/112,671, filed on Feb. 06, 2015 in the U.S. Patent Office, and to Korean Patent Application No. 10-2015-0052549, filed on Apr. 14, 2015 in the Korean Intellectual Property Office, the entire contents of which are hereby incorporated by reference.

### BACKGROUND

The inventive concepts described herein relate to an electronic device, and more particularly, to a data transmission method for an electronic device.

In mobile terminals such as smart phones, security risks exist such as in the case of personal computers (PCs). For example, there exists a risk of leakage and/or dissemination of personal information (e.g., address books, text messages, financial information, authentication, personal health information, etc.) due to the open market ecosystems in which mobile terminals are used. Terminal malfunctions may occur due to a malicious code, excessive charging induction, and possible attacks on mobile communication networks. Moreover, as wireless communication environments expand, new types of security risks may be expected. To protect user and network assets from security risks by malicious attacks, security platform technology that may provide reliability in mobile environments is needed. Security platform technology provides enhanced security functionality using hardware inside a CPU of a smart phone to provide a trusted execution environment (TEE).

### SUMMARY

Embodiments of the inventive concept provide a data transmission method of an electronic device having a secure element. The data transmission method may include executing a trusted application on a trusted execution environment; taking an ownership with respect to the secure element using a personal identification number (PIN) in the trusted execution environment; collecting data related to personal information of a user; after obtaining the ownership, encrypting the data in the secure element; and outputting the encrypted data to an external server.

Embodiments of the inventive concept provide an electronic device. The electronic device may include a sensor sensing data related to personal information of a user; an application processor configured to include a rich execution environment executing at least one application, and a trusted execution environment that provides a secure level with respect to an attack from the rich execution environment and that executes a trusted application to collect the data from the sensor; and a secure element configured to execute communication with the trusted execution environment by a secure protocol using a personal identification number of the user. The collected data is encrypted by the secure element, and the encrypted data is transmitted to an external server.

Embodiments of the inventive concept provide an electronic device including a device body configured to input and display data, and to perform communication; and a band attached to the device body and having at least one sensor configured to sense data related to personal information of a user. The band is configured to be wearable by the user. The device body includes an application processor including a trusted execution environment configured to provide a secure level against unauthorized external access and to execute a trusted application to collect the data from the at least one sensor; and a secure element configured to execute communication with the trusted execution environment by a secure protocol using a personal identification number of the user. The collected data is encrypted by the secure element, and the encrypted data is transmitted to the external server.

### BRIEF DESCRIPTION OF THE DRAWINGS

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 illustrates a diagram of an electronic device, according to an embodiment of the inventive concept.

FIG. 2 illustrates a diagram of a health data protection method of an electronic device, according to an embodiment of the inventive concept.

FIG. 3 illustrates a diagram of an ownership acquisition process using a trusted execution environment (TEE) and a secure element (SE), according to an embodiment of the inventive concept.

FIG. 4 illustrates a diagram of an authentication and key exchange using TEE and SE, according to an embodiment of the inventive concept.

FIG. 5 illustrates a diagram of a key generation process using TEE and SE, according to an embodiment of the inventive concept.

FIG. 6 illustrates a diagram of a key loading process using TEE and SE, according to an embodiment of the inventive concept.

FIG. 7 illustrates a diagram of a key storing process using TEE and SE, according to an embodiment of the inventive concept.

FIG. 8 illustrates a diagram of a key retrieval process using TEE and SE, according to an embodiment of the inventive concept.

FIG. 9 illustrates a diagram of a key removal process using TEE and SE, according to an embodiment of the inventive concept.

FIG. 10 illustrates a diagram of a sign generation process using TEE and SE, according to an embodiment of the inventive concept.

FIG. 11 illustrates a diagram of a sign verification process using TEE and SE, according to an embodiment of the inventive concept.

FIG. 12 illustrates a diagram of a hash-based message authentication code (HMAC) generation process using TEE and SE, according to an embodiment of the inventive concept.

FIG. 13 illustrates a diagram of an HMAC verification process using TEE and SE, according to an embodiment of the inventive concept.

FIG. 14 illustrates a diagram of a data encryption process using TEE and SE, according to an embodiment of the inventive concept.

FIG. 15 illustrates a diagram of a data decryption process using TEE and SE, according to an embodiment of the inventive concept.

FIG. 16 illustrates a diagram of a random (RAND) generation process using TEE and SE, according to an embodiment of the inventive concept.

FIG. 17 illustrates a diagram of a wearable watch, according to an embodiment of the inventive concept.

### DETAILED DESCRIPTION

Embodiments of inventive concepts will be described more fully hereinafter with reference to the accompanying drawings, in which exemplary embodiments of the inventive concept are shown. The inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It should be understood that, although the terms first, second, etc. may be used herein to describe various elements, the various elements should not be limited by these terms. These terms are only used to distinguish one element from another. For example, a first region/layer could be termed a second region/layer, and, similarly, a second region/layer could be termed a first region/layer without departing from the teachings of the disclosure. It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

It should be further understood that the terms “comprises” and/or “comprising,” or “includes” and/or “including” when used in this specification and claims, specify the presence of stated features, regions, integers, steps, operations, elements, and/or components, but do not preclude the presence or addition of one or more other features, regions, integers, steps, operations, elements, components, and/or groups thereof. The terminology used herein is for the purpose of describing particular embodiments only and is not intended to be limiting of the inventive concept. As used herein, the singular forms “a”, “an” and “the” are intended to include the plural forms as well, unless the context clearly indicates otherwise.

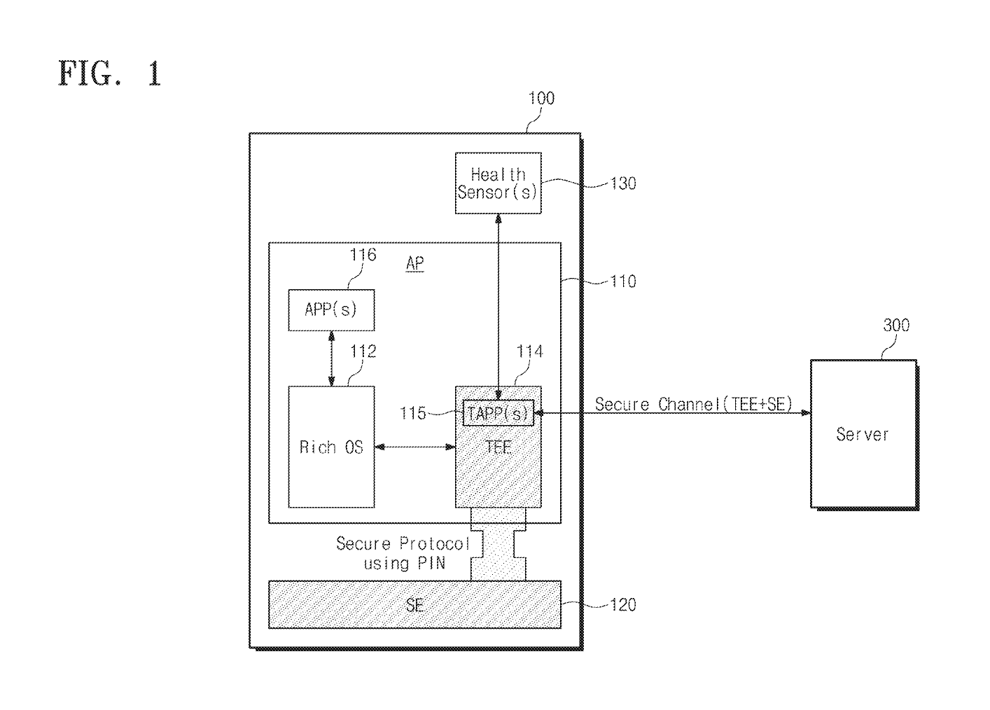

FIG. 1 illustrates a diagram of an electronic device 100, according to an embodiment of the inventive concept. Referring to FIG. 1, the electronic device 100 performs communication with a server 300 through a secure channel The secure channel is formed by a trusted execution environment (TEE) 114 and a secure element (SE).

The electronic device 100 may be one of various devices such as a smart phone, a tablet personal computer (PC), a mobile phone, a video phone, an e-book reader, a desktop PC, a laptop PC, a netbook computer, a personal digital assistant (PDA), a portable multimedia player (PMP), an MP3 player, a mobile medical appliance, an electronic bracelet, an electronic necklace, an electronic accessory, a camera, a wearable device, an electronic clock, a wrist watch, a home appliance (e.g., a refrigerator, an air conditioner, a cleaner, an oven, a microwave oven, a washing machine, an air cleaner, etc.), an intelligent robot, a TV, a digital video disk (DVD) player, an audio device, any sort or type of medical appliance (e.g., magnetic resonance angiography (MRA), magnetic resonance imaging (MRI), a computed tomography (CT), a movie camera, an ultrasonic machine, etc.), a navigation device, a global positioning system (GPS) receiver, an event data recorder (EDR), a flight data recorder (FDR), a set-top box, a TV box (e.g., Samsung HomeSync™, an Apple TV™, or a Google TV™), an electronic dictionary, a vehicle infotainment device, an electronic equipment for a ship (e.g., navigation equipment for a ship, a gyrocompass, etc.), an avionics device, a security device, an electronic cloth, an electronic key, a camcorder, a game console, a head-mounted display (HMD), a flat panel display device, an electronic picture frame, an electronic album, a furniture or a building including a communication function, a part of structure, an electronic board, an electronic signature receiving device and a projector, or combinations thereof. For convenience of description, it is assumed that the electronic device 100 is a wearable device. However, the inventive concept is not limited to the wearable device and/or the various devices listed above.

The electronic device 100 includes an application processor 110, at least one secure element (SE) 120, and at least one health sensor 130.

The application processor 110 includes a rich OS (operating system) 112 (or a rich execution environment (REE)), a trusted execution environment (TEE) 114 and at least one application (APP(s)) 116.

The rich OS 112 is an environment for diversity and abundance that executes the at least one application 116. For example, the rich OS 112 may be an Android, an Android Wear, a Symbian OS, a Windows OS, a Tizen, or the like, but should not be limited to these examples. The rich OS 112 may be downloaded from a third file after manufacturing a device.

The TEE 114 is constituted by hardware, firmware and software, and provides a protection level from a software attack generated in the rich OS 122. The TEE 114 controls access of and an execution of a sensitive application which needs to be separated from the rich OS 112. That is, TEE 114 controls access and execution of at least one trusted application 115. The TEE 114 may include at least one trusted application TAPP(s) 115.

The trusted application TAPP(s) 115 receives and processes health data provided from the health sensor 130, and transmits relevant health data to the external server 300 through a secure channel In other embodiments, the trusted application TAPP(s) 115 may be a secure application (digital right management (DRM), bank, payment, corporate, or the like). The secure channel is not directly formed between the trusted application TAPP(s) 115 and the server 300, but is formed after performing user authentication through the SE 120. The health data transmitted through the secure channel may be encrypted through the SE 120.

The SE 120 may be constituted by software and tamper resistant hardware, may provide high-level security and may work in cooperation with TEE 114. The SE 120 may include a native operating system (OS), a security storage device which is an internal data storing place, an access control block controlling an access authority to the SE 120, a key management block, a digital signature block, a security function block performing encryption/decryption, and a firmware update block for updating firmware of the SE 120.

The SE 120 may be, for example, a universal IC card (UICC) (e.g., universal subscriber identity module (USIM), CDMA subscriber identity module (CSIM), IP multimedia services identity module (ISIM), a subscriber identity module (SIM) card, an embedded secure element (eSE), a micro secure digital card (microSD), Stickers, or the like, but should not be limited to these examples. The SE 120 may communicate with the TEE 114 by a secure protocol using a PIN (personal identification number). That is, the secure protocol may be activated by a PIN which a user of the electronic device 100 knows. However, the secure protocol of the inventive concept is not limited thereto. The secure protocol of the inventive concept may be embodied to communicate using body information (e.g., fingerprint, iris, or the like) of a user of the electronic device 100.

The health sensor 130 is embodied to sense body information or health data from at least one user. For example, the health sensor 130 may sense a heartbeat, oxygen concentration in a blood vessel, blood pressure, blood sugar, or body fat, among other body information. The health sensor 130 is included in the electronic device 100 but the inventive concept is not limited thereto. The health sensor may be a device that exists outside the electronic device 100, and the health data measured in the health sensor may be transmitted to the electronic device 100 through various wired/wireless communications.

The health sensor 130 senses body information or health data of a user. However, the inventive concept should not be limited to a sensor sensing body information or health data of a user. Selectively, any kind of sensor sensing and/or outputting data related to personal information of a user may be used instead of the health sensor 130 of FIG. 1.

The server 300 may be embodied to manage health data of a user through storage, analysis and feedback of the health data of the user, and to provide the health data to a doctor or a pharmacist when necessary.

The electronic device 100 may form a secure channel after performing an authentication using a simple secure protocol using a PIN (personal identification number) between the TEE 114 and SE 120, and may safely transmit the encrypted health data to the external server 300.

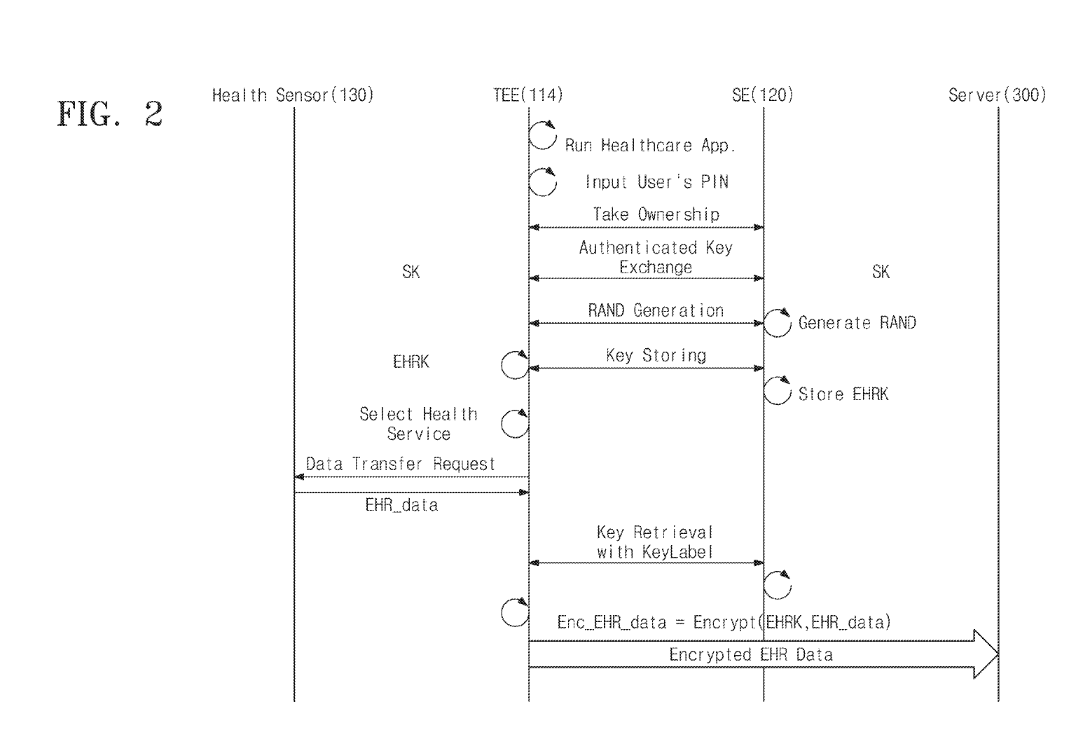

FIG. 2 illustrates a diagram of a health data protection method of an electronic device, according to an embodiment of the inventive concept. A user performs an initial use registration on the electronic device 100. An ownership is determined. The ownership may be a kind of use authority with respect to the SE 120. A user executes the trusted application TAPP(s) 115 of the electronic device 100, which may be related to health. Health data (or data related to personal information) measured in the health sensor 130 is collected. Health data of a user is encrypted in the TEE 114 and may be transmitted to the server 300 through a gate way (for example, a device making it possible to connect to an internet through a mobile communication or a wideband network such as a smart phone, WiFi access point, a wired sharer, or the like).

When encrypting health data in TEE 114, an encryption key may be safely protected in the SE 120. A security operation such as encryption/decryption, key generation and storage, signature generation and verification with respect to health data of a user may be performed through a secure protocol with the SE 120.

The health data protection process in accordance with exemplary embodiments of the inventive concept proceeds as follows. The trusted application TAPP(s) 115 is executed in the electronic device 100 (Run Healthcare App in FIG. 2). A user registration is performed in the SE 120 to receive a reinforcement security from the electronic device 100. At this time, the user registration may be completed by inputting a PIN. The PIN may be safely inputted through a trusted user interface (UI) such as a keypad or a screen for example (Input User's PIN). After that, the SE 120 generates a root key corresponding to a user based on the PIN. The SE 120 stores the PIN in advance and may give an ownership to a user through PIN verification (Take Ownership).

The TEE 114 performs an exchange process of authentication and a key (Authenticated Key Exchange). An internal secure channel is formed between the TEE 114 and the SE 120. Formation of the internal secure channel means that data is transmitted using a session key (SK) shared between the TEE 114 and the SE 120. The TEE 114, which is constituted by hardware and thus secure, may provide access to the SE 120 through the secure channel safely while preventing an external attack. The TEE 114 generates a random number RAND (RAND Generation) which is safe in hardware from the SE 120, and generates a key EHRK for user health data protection based on the random number RAND. The key EHRK is used to encrypt the health data. The key EHRK generated in the TEE 114 is safely stored in the SE 120 (Key Storing).

The health sensor 130 checks a health condition of a user (Select Health Service), and responsive to a request by the TEE 114 (Data Transfer Request) transmits generated health data (EHR_Data) to the TEE 114. At this time, the health data EHR of a user may be safely collected in the TEE 114 of the electronic device 100. For the sake of a security of the health data of a user safely collected in the TEE 114, the TEE 114 retrieves a key EHRK stored in the SE 120 (Key Retrieval with KeyLabel) to use it in the TEE 114. The collected health data of a user is encrypted using the encryption key EHRK generated in the SE 120, and then may be safely transmitted to the server 300 (Encrypted EHR Data) for managing the health data. That is, health data (EHR) may be transmitted to the external server 300 through a secure channel.

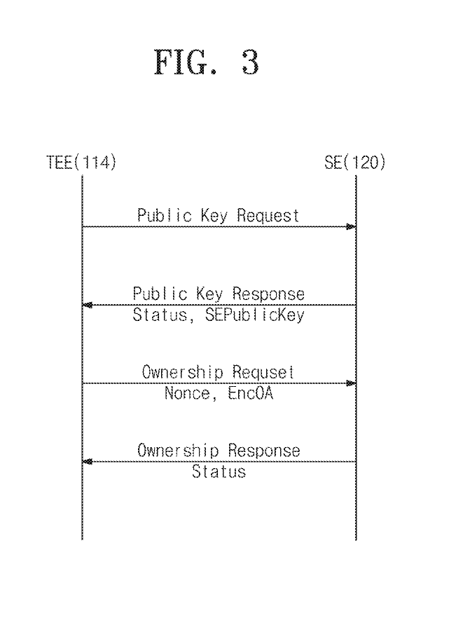

FIG. 3 illustrates a diagram of an ownership acquisition process using TEE 114 and SE 120, according to an embodiment of the inventive concept. A secure protocol between the TEE 114 and the SE 120 may be embodied through various communication interfaces such as RS232, inter-integrated circuit (I2C), serial peripheral interface (SPI), ISO 7816, or the like.

A process in which a user secures an ownership for usage of the SE 120 is as follows. A user has to secure an authority from the SE 120 to safely store secret information (credential or secret) in the SE 120. A process of securing a use authority of the SE 120 is a take ownership. A user inputs a PIN using a trusted user interface (UI) safely protected from an external attack of the electronic device 100. The SE 120 may generate a SRK (storage root key) corresponding to the PIN of a user.

If ownership with respect to a use of the SE 120 of a user is determined, the TEE 114 requests a public key (e.g., RSA 2048 public key) of the SE 120 (Public Key Request in FIG. 3). The public key of the SE 120 is needed to encrypt ownership authentication data (OwnerAuth). The ownership authentication data may be a value obtained by hashing the PIN of a user received from the trusted UI using a hash function (e.g., secure hash algorithm-256 (SHA-256)). The hash function is input with information of random length and outputs a hash value of a fixed length. The hash function is not limited to SHA-256 and a generally safe hash function such as SHA-1, SHA-512, or the like may be used.

The SE 120 transmits a public key (e.g., RSA 2048 public key) of the SE 120 and a status (Status) to the TEE 114 in response to a public key request (Public Key Response). For example, the public key of the SE 120 may be transmitted in the form of a 256 byte modulus and an exponent (e.g., fixed to “0x010001”). The Status includes information whether the public key request is successfully performed.

After that, after receiving a public key from the SE 120, the TEE 114 encrypts the ownership authentication data (OwnerAuth). At this time, RSA-optimal asymmetric encryption padding (OAEP) v2.2 may be used as a public key algorithm

After that, an ownership request of the TEE 114 is made (Ownership Request). The TEE 114 transmits a Nonce (an arbitrary number that may be used only once) generated through an internal random number generator and a value EncOA obtained by RSA-encrypting the ownership authentication data (OwnerAuth) using a public key of the SE 120 to the SE 120.

After that, the SE 120 which received the ownership request decrypts the EncOA using a private key of the SE 120. The OwnerAuth may be safely stored in a secure storage device (e.g., a secure non-volatile random access memory (NVRAM)) of the SE 120. The SE 120 generates a storage root key (SRK) through a random number generator and may safely store the generated storage root key SRK in the secure storage device (e.g., a secure NVRAM) of the SE 120.

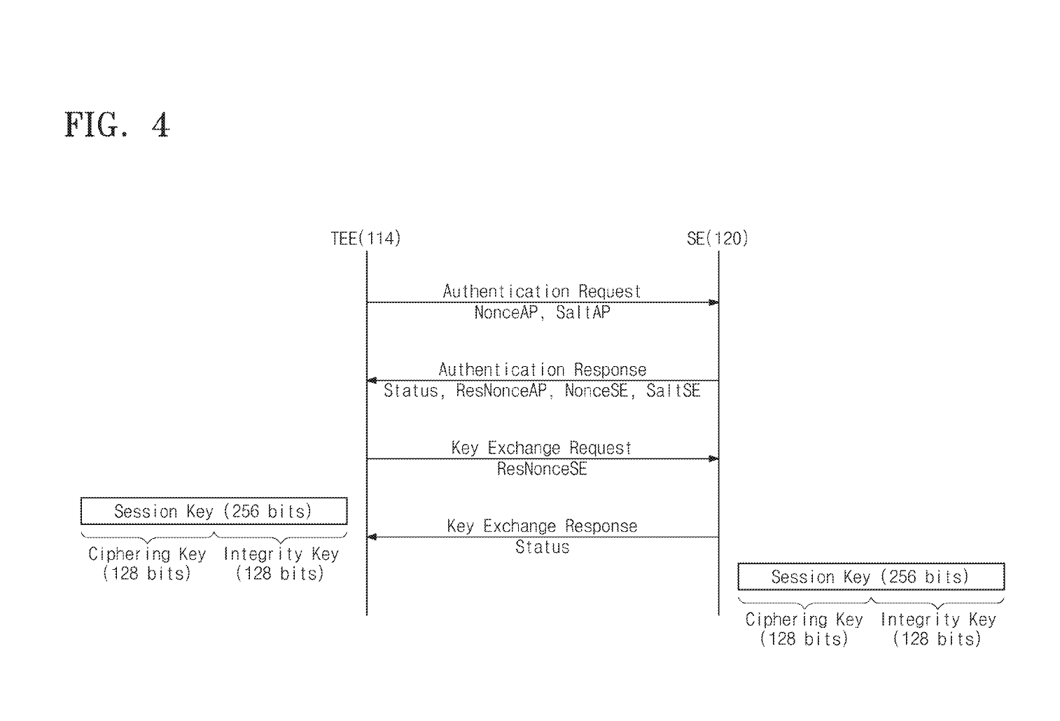

FIG. 4 illustrates a diagram of an authentication and key exchange using TEE 114 and SE 120, according to an embodiment of the inventive concept.

To set a secure channel between the TEE 114 and the SE 120, an authentication and key exchange process (AKE) is performed. After performing the AKE process, a shared session key SK is formed between the TEE 114 and the SE 120. A ciphering key CK and an integrity key IK may be induced through a session key SK (e.g., 128 bit symmetric key). The ciphering key CK may be used to encrypt a secure channel and the integrity key IK may be used to verify integrity of transmit/receive message between secure channels.

An authentication request by the TEE 114 proceeds as follows. The TEE 114 generates NonceAP and SaltAP through a random number generator, and stores the generated NonceAP and SaltAP until a session key SK is generated. The SaltAP is random data and, when the session key SK is generated, the SaltAP may be concatenated with OwnerAuth to be used as an input of a hash function. This increases freshness of the session key SK. The authentication request is sent to the SE 120 (Authentication Request in FIG. 4) along with the NonceAp and the SaltAP.

A response to the authentication request of the SE 120 proceeds as follows. After receiving the authentication request, the SE 120 stores the received SaltAP to generate a session key SK and generates a ResNonceAP (e.g., SHA-256 (OwnerAuth 1 NonceAP)). The SE 120 generates NonceSE and SaltSE through a random number generator and stores the generated NonceSE and SaltSE until a session key SK is generated.

After that, the SE 120 transmits a response to the authentication request to the TEE 114 (Authentication Response). The authentication response may include a status (Status) (processing result of the authentication request), ResNonceAP, NonceSE and SaltSE.

A key exchange process between the TEE 114 and the SE 120 proceeds as follows. After receiving an authentication response from the SE 120, the TEE 114 calculates an OwnerAuth (=SHA-256(PIN)) after receiving a PIN from a user through a trusted UI. After calculating a ResNonceAP, the TEE 114 performs an authentication with respect to the SE 120 by verifying whether the calculated ResNonceAP equals the ResNonceAP received from the SE 120.

The TEE 114 stores OwnerAuth and SaltSE. The TEE 114 may store OwnerAuth and SaltSE until a session key SK is generated. The TEE 114 also generates a ResNonceSE (e.g., SHA-256 (OwnershipAuth|NonceSE)). The TEE 114 may store the ResNonceSE until a key exchange request is transmitted.

After an authentication with respect to the SE 120 is successfully performed, a session key SK is generated. For example, the session key SK may be SHA-256 (OwnershipAuth|SaltSE|SaltAP), a ciphering key CK may be the first 128 bits of the session key SK and an integrity key IK may be last 128 bits. The TEE 114 transmits a key exchange request to the SE 120 (Key Exchange Request). The key exchange request may include ResNonceSE.

A key exchange response of the SE 120 proceeds as follows. After receiving a key exchange request from the TEE 114, the SE 120 loads the stored OwnerAuth on an internal RAM of the SE 120. The SE 120 checks whether the ResNonceSE (e.g., SHA-256 (OwnerAuth|NonceSE)) value is right and authenticates a user of the TEE 114. If a user authentication succeeds, the SE 120 generates a session key SK. For example, the session key SK may be SHA-256 (OwnershipAuth|SaltSE|SaltAP), a ciphering key CK may be the first 128 bits of the session key SK and an integrity key IK may be the last 128 bits.

After the session key SK is successfully generated, the SE 120 transmits the key exchange response to the TEE 114 (Key Exchange Response). The key exchange response may include a generation of the session key SK and may include a status (Status) with respect to whether the key exchange request is successfully performed.

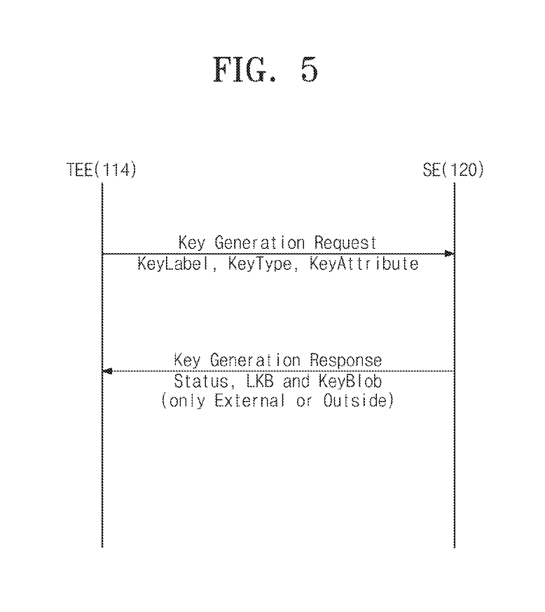

FIG. 5 illustrates a diagram of a key generation process using TEE 114 and SE 120, according to an embodiment of the inventive concept.

The TEE 114 requests a key generation in the SE 120. For example, the SE 120 may generate a key of RSA 1024/2048 bit, advanced encryption standard (AES) 128/256 bit, keyed-hash message authentication code (HMAC) 128/256, or the like. The generated key may be stored inside the SE 120, may be stored outside the SE 120 after being encrypted into a storage root key SRK, or may be stored outside the SE 120 after being stored as a session key SK. A storage place of the key (inside of the SE 120, outside of the SE 120, outside of the TEE 114) may be determined to suit a user request or a user environment.

A key generation request (Key Generation Request in FIG. 5) by the TEE 114 proceeds as follows. The TEE 114 generates a key generation message according to a keyType and a keyAttribute of a key to be generated in the SE 120. The request message may include a keyLabel. The keyLabel is an only value representing a key in the TEE 114.

A key generation response (Key Generation Response) of the SE 120 proceeds as follows. After receiving the key generation request, the SE 120 may generate an RSA key pair (public key, private key), an AES key, an HMAC key, or the like. A storage option of the generated key may be determined according to the key Attribute. If the key Attribute is an internal device (internal (0x00)), the key may be stored in a shield location of the SE 120. If the key Attribute is an external device (external (0x01)), the key may be stored outside the SE 120, that is, in the TEE 114. The Status includes information whether the key generation request is successfully performed to the TEE 114 in response to the key generation request (Key Generation Response), LKB and KeyBlob, where LKB is a length of KeyBlob and KeyBlob is an encrypted key and a message authentication code (MAC) that are securely delivered from the SE 120 to the TEE 114.

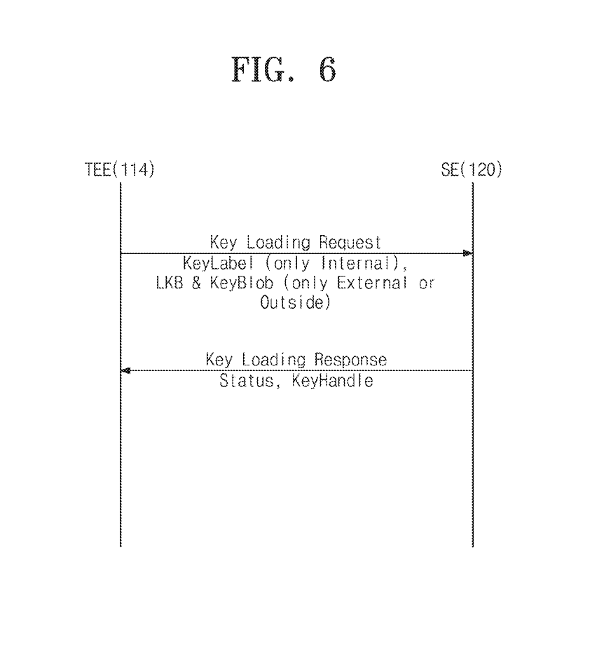

FIG. 6 illustrates a diagram of a key loading process using TEE 114 and SE 120, according to an embodiment of the inventive concept. The TEE 114 may perform a ciphering operation of encryption/decryption/signature/HMAC/etc. using a key stored in the SE 120. Because of this, a key to be used has to be loaded on a RAM of the SE 120. At this time, a key loading process is used.

The key loading process proceeds as follows. The TEE 114 transmits a key loading request (Key Loading Request in FIG. 6) to the SE 120 to load a key on the SE 120. A request message, in the case of an internal key, may include a keyLabel and in the case of an external key or an outside key, may include a LKB (length of key block).

A key loading response of the SE 120 proceeds as follows. After receiving the key loading request, the SE 120 loads a corresponding key on a RAM of SE 120. In the case that the requested key is an internal key, a key corresponding to the KeyLabel is taken out of the shielded location of the SE 120 to be loaded on a RAM. In the case that the requested key is an external key or an outside key, a key included in a KeyBlob is loaded on the RAM.

After loading the request key on the RAM, the SE 120 transmits a key loading response (Key Loading Response) to the TEE 114. The key loading response may include a processing result (Status) and a loaded key. That is, the SE 120 transmits a status (Status) with respect to whether the key loading request is successfully performed to the TEE 114 in response to the key loading request (Key Loading Response), and KeyHandle, where KeyHandle is a unique value to identify the key stored in the SE120. The TEE 114 can use the loaded key using the right KeyHandle.

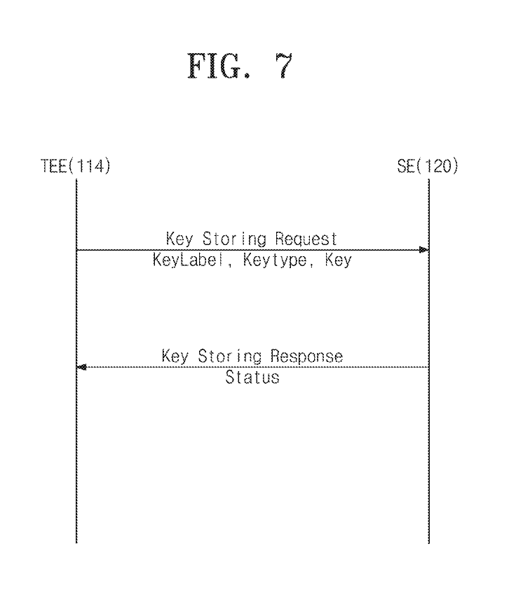

FIG. 7 illustrates a diagram of a key storing process using TEE 114 and SE 120, according to an embodiment of the inventive concept. The TEE 114 may safely store a key generated in the TEE 114 and from the outside of the TEE 114 in a tamper resistant secure area, that is, a secure storage device. The TEE 114 may safely store a key in the SE 120 through a key storing request and a key storing response.

A key storing request of the TEE 114 proceeds as follows. The TEE 114 transmits the key storing request (Key Storing Request in FIG. 7) to the SE 120. A key storing request message may include a KeyLabel, KeyType (RSA 1024/2048, AES 128/256, HMAC 128/256, or the like) of a key that is desired to be stored in the SE 120.

A key storing response of the SE 120 proceeds as follows. After receiving the key storing request from the TEE 114, the SE 120 stores a corresponding key in a physically safe secure area (for example, in NVRAM). After safely storing the key, the SE 120 transmits a key storing response (Key Storing Response) notifying a processing result (Status) to the TEE 114.

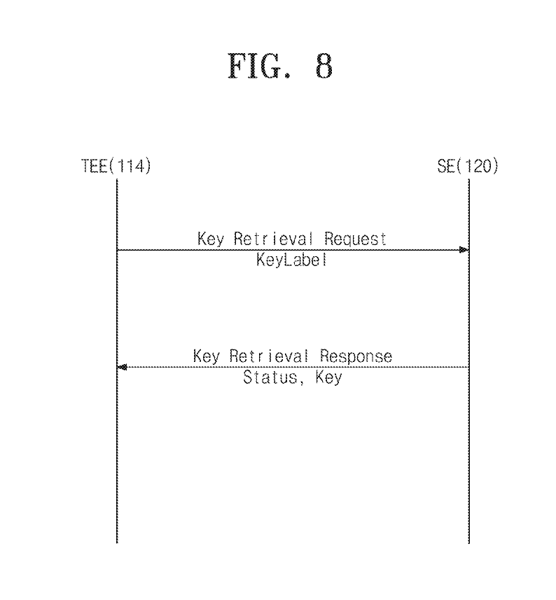

FIG. 8 illustrates a diagram of a key retrieval process using TEE 114 and SE 120, in accordance with an embodiment of the inventive concept. After safely storing a key generated from the TEE 114 and from outside of the TEE 114 in a tamper resistant storage device of the SE 120, the TEE 114 may safely retrieve the key stored in the SE 120 through a key retrieval request/response when the TEE 114 wants to use the stored key.

A key retrieval request of the TEE 114 proceeds as follows. The TEE 114 transmits the key retrieval request (Key Retrieval Request in FIG. 8) to the SE 120. The key retrieval request message may include a KeyLabel of a key stored in the SE 120.

A key retrieval response of the SE 120 proceeds as follows. After receiving the key retrieval request from the TEE 114, the SE 120 checks a key value corresponding to the KeyLabel in a physically safe secure area inside the SE 120. The SE 120 generates a key retrieval response (Key Retrieval Response) to safely transmit the key value checked in the secure area to the TEE 114 and transmits a response including a key retrieval result (Status) and a key to the TEE 114.

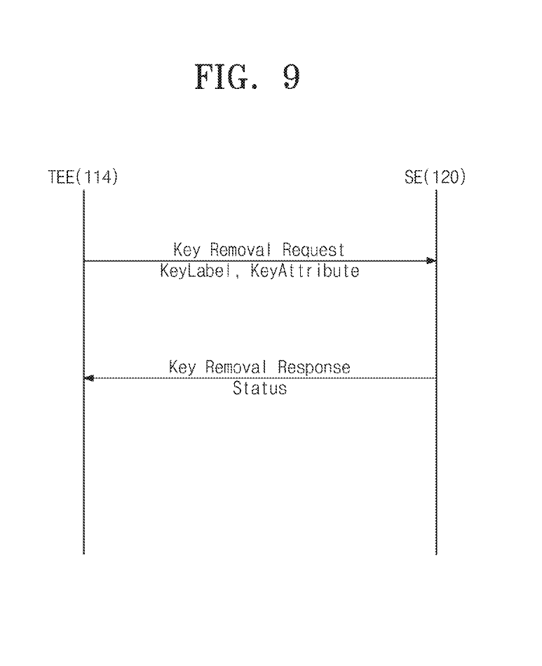

FIG. 9 illustrates a diagram of a key removal process using TEE 114 and SE 120, according to an embodiment of the inventive concept. After safely storing a key generated from the TEE 114 and from outside of the TEE 114 in a tamper resistant storage device of the SE 120, the TEE 114 may safely remove a key when an event such as a service life expiration of a corresponding key, a key renewal, or the like occurs.

A key removal request of the TEE 114 proceeds as follows. The TEE 114 transmits the key removal request (Key Removal Request in FIG. 9) to the SE 120. The key removal request message includes a KeyLabel and KeyAttribute (internal, external) of a key stored in the SE 120. In the case that the KeyAttribute is internal, the key removal request message represents a key generated by the SE 120, and in the case that the KeyAttribute is external, the key removal request message represents a key generated by the TEE 114.

A key removal response of the SE 120 proceeds as follows. After receiving the key removal request from the TEE 114, the SE 120 removes a key value corresponding to a KeyLabel in a physically safe secure area inside the SE 120. The SE 120 safely removes the key value in the secure area, generates a key removal response (Key Removal Response) and transmits a response including a key removal result (Status) to the TEE 114.

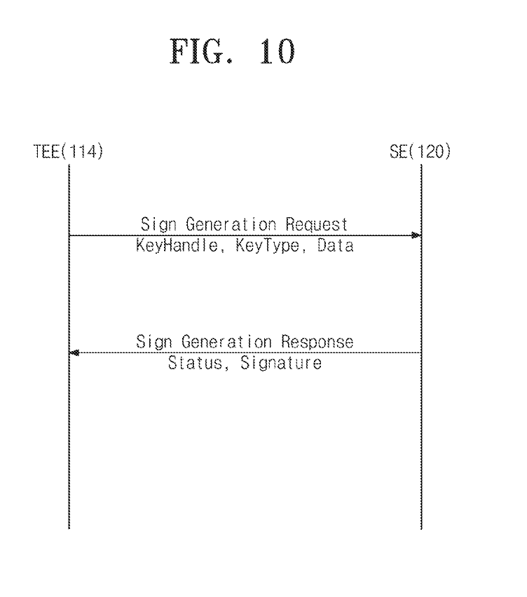

FIG. 10 illustrates a diagram of a sign generation process using TEE 114 and SE 120, according to an embodiment of the inventive concept. The TEE 114 requests a sign generation with respect to a hash value of data in the SE 120. The SE 120 generates a signature value (PKCS #1 RSA_PSS) with respect to the data. A RSA 1024/2048 key is loaded in advance through a key loading command.

The sign generation request of the TEE 114 proceeds as follows. The TEE 114 transmits the sign generation request (Sign Generation Request in FIG. 10) to the SE 120. The sign generation request message may include a value obtained by hashing KeyHandle, KeyType (RSA 1024, RSA 2048) and data of a key loaded in the SE 120 using a hash function (for example, SHA256).

The sign generation response of the SE 120 proceeds as follows. After receiving a sign generation request from the TEE 114, the SE 120 signs the received data by a key of KeyHandle. The SE 120 generates a sign generation response (Sign Generation Response) and transmits a response including a signature value with respect to data (Signature) and a sign generation result (Status) to the TEE 114.

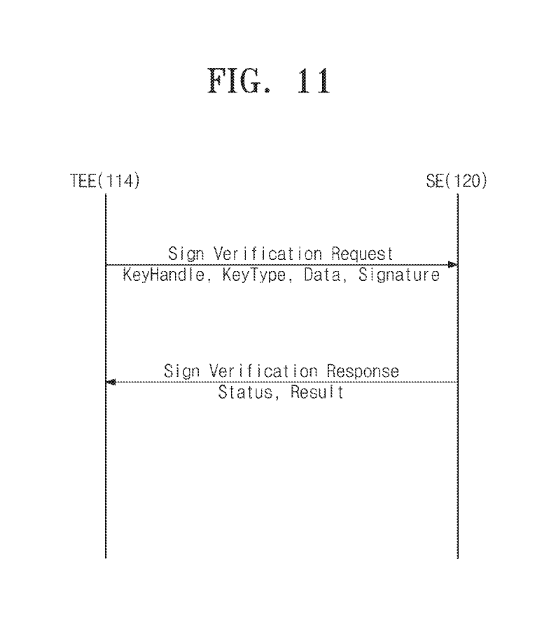

FIG. 11 illustrates a diagram of a sign verification process using TEE 114 and SE 120, according to an embodiment of the inventive concept.

The TEE 114 requests verification with respect to a signature of data in the SE 120. The SE 120 verifies a signature value (PKCS #1 RSA_PSS) with respect to data. A RSA 1024/2048 key is loaded in advance through a key loading command.

A sign verification request of the TEE 114 proceeds as follows. The TEE 114 transmits the sign verification request (Sign Verification Request in FIG. 11) to the SE 120. The sign verification request message may include a value obtained by hashing KeyHandle, KeyType (RSA 1024, RSA 2048) and data with respect to a key used in a signature (Signature) using a hash function (for example, SHA256).

A sign verification response of the SE 120 proceeds as follows. After receiving a sign verification request from the TEE 114, the SE 120 verifies the received data by a key of KeyHandle. The SE 120 generates the sign verification response (Sign Verification Response) and transmits a response (Status, Result) including a verification value (Result, 0x00 (False) or 0x01 (True)) with respect to the data to the TEE 114.

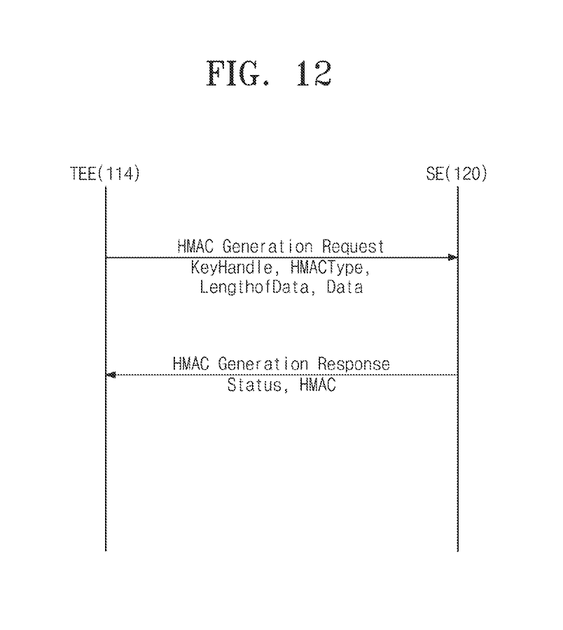

FIG. 12 illustrates a diagram of a hash-based message authentication code (HMAC) generation process using TEE 114 and SE 120, according to an embodiment of the inventive concept. The TEE 114 requests a HMAC value with respect to data in the SE 120. A supporting hash function is SHA-256 and may support a 128-bit key and a 256-bit key. A HMAC key is loaded through a key loading command

A HMAC generation request of the TEE 114 proceeds as follows. The TEE 114 transmits the HMAC generation request (HMAC Generation Request in FIG. 12) to the SE 120. The HMAC generation request message may include KeyHandle and HMACType (128 bit key or 256 bit key) corresponding to a key loaded in the SE 120 and a data length (LengthofData) and data requesting HMAC.

A HMAC generation response of the SE 120 proceeds as follows. After receiving the HMAC generation response from the TEE 114, the SE 120 calculates HMAC of the received data using a key of KeyHandle. The SE 120 generates the HMAC generation response (HMAC Generation Response) and transmits a response including a HMAC value (HMAC) with respect to data and a HMAC generation result (Status) to the TEE 114.

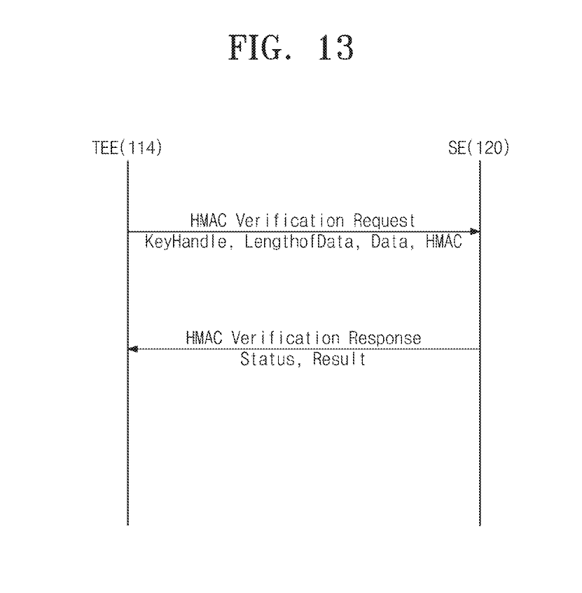

FIG. 13 illustrates a diagram of a HMAC verification process using TEE 114 and SE 120, according to an embodiment of the inventive concept. The TEE 114 verifies HMAC calculated through a HMAC generation request in the SE 120. The same HMAC key used in the HMAC generation request is loaded.

A HMAC verification request of the TEE 114 proceeds as follows. The TEE 114 transmits the HMAC verification request (HMAC Verification Request in FIG. 13) to the SE 120. The HMAC verification request message may include KeyHandle and KeyType (HMAC 128/HMAC 256), data length, data, a HMAC value (HMAC) with respect to a key necessary for a HMAC calculation.

A HMAC verification response of the SE 120 is as follows. After receiving the HMAC verification request from the TEE 114, the SE 120 verifies a HMAC value of the received data using a key of KeyHandle. The SE 120 generates a HMAC verification response (HMAC Verification Response) and transmits a response (Status, Result) including a verification value (Result, 0x00 (False) or 0x01 (True)) with respect to the data to the TEE 114.

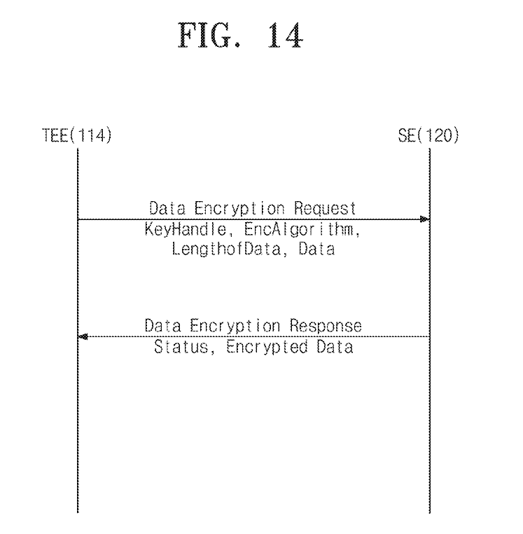

FIG. 14 illustrates a diagram of a data encryption process using TEE 114 and SE 120, according to an embodiment of the inventive concept. The TEE 114 requests an encryption with respect to data in the SE 120. The SE 120 may support AES-128 and AES-256 and use a cipher feedback (CFB) mode in an encryption operation. An AES key is loaded in a RAM of the SE 120 through a key loading command

A data encryption request of the TE 114 proceeds as follows. The TEE 114 transmits the data encryption request (Data Encryption Request in FIG. 14) to the SE 120. The data encryption request message may include KeyHandle and KeyType (AES 128/AES 256), data length and a data value with respect to a key to be used in an encryption.

A data encryption response of the SE 120 proceeds as follows. After receiving a data encryption request from the TEE 114, the SE 120 encrypts the received data using a key of KeyHandle. The SE 120 may generate a random 16 byte initial value (IV) and encrypt data in an AES CFB mode. The SE 120 generates a data encryption response (Data Encryption Response) and transmits a response including an IV (initial value) with respect to the data, a data status (Status) and an encrypted data to the TEE 114.

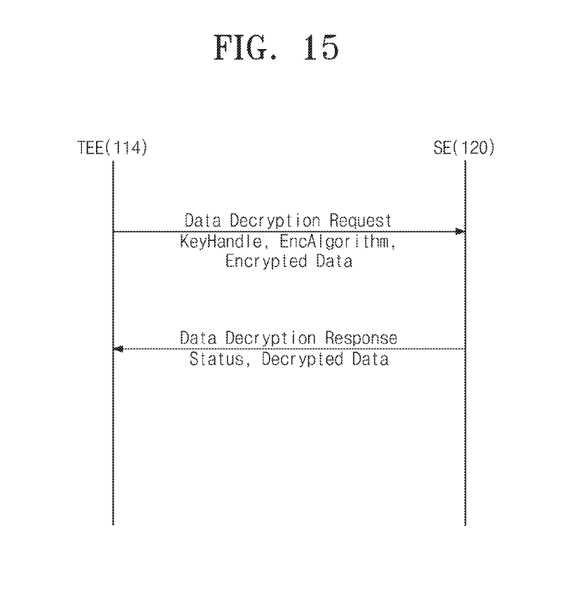

FIG. 15 illustrates a diagram of a data decryption process using TEE 114 and SE 120, according to an embodiment of the inventive concept. The TEE 114 requests a decryption with respect to data encrypted through the data encryption request in the SE 120. An AES key is loaded in a RAM of the SE 120 through a key loading command

A data decryption request of the TEE 114 proceeds as follows. The TEE 114 transmits the data decryption request (Data Decryption Request in FIG. 15) to the SE 120. The data decryption request message may include KeyHandle and KeyType (AES 128/AES 256), an IV (initial value), data length and encrypted data with respect to a key used in an encryption.

A data decryption response of the SE 120 proceeds as follows. After receiving a data decryption request from the TEE 114, the SE 120 decrypts the received data using a key of KeyHandle and the received IV. The SE 120 generates a data decryption response (Data Decryption Response) and transmits a response including the decrypted data to the TEE 114.

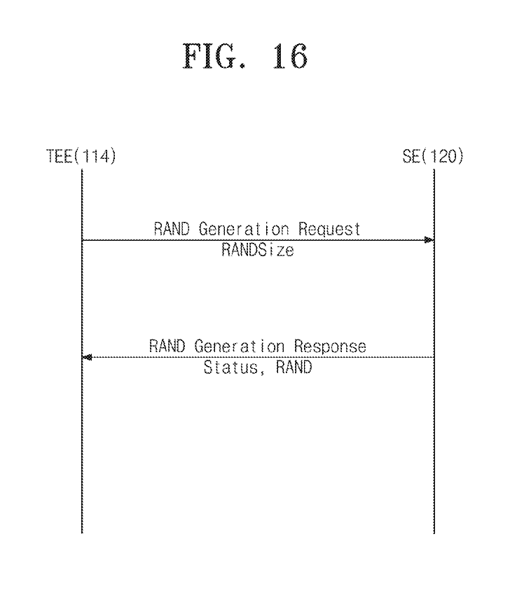

FIG. 16 illustrates a diagram of a random (RAND) generation process using TEE 114 and SE 120, according to an embodiment of the inventive concept. The TEE 114 requests a RAND in the SE 120. The SE 120 may generate a RAND of maximum 240 byte.

A RAND generation request of the TEE 114 proceeds as follows. The TEE 114 transmits the RAND generation request (RAND Generation Request in FIG. 16) to the SE 120. The RAND generation request message may include the number of bytes of random number (RANDSize) being requested.

A RAND generation response of the SE 120 proceeds as follows. After receiving the RAND generation request from the TEE 114, the SE 120 may generate RAND according to the number of bytes of random number being requested. The SE 120 generates the RAND generation response (Status) and transmits a response including RAND to the TEE 114.

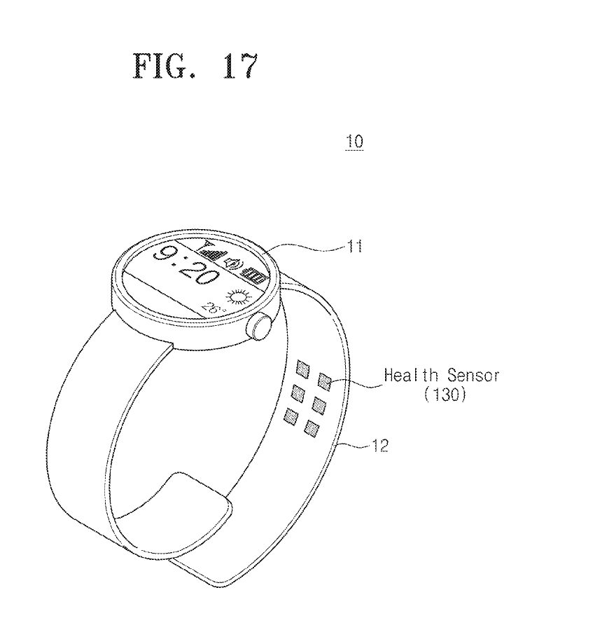

FIG. 17 illustrates a diagram of a wearable watch 10, according to an embodiment of the inventive concept. Referring to FIG. 17, the wearable watch 10 includes a watch body 11 for performing a wireless communication, inputting data (image, picture, character, etc.) and displaying data, and a watch band 12 which may be used to attach the watch 10 to a user's wrist.

The watch body 11 may include a processor, a memory, an input/output (I/O) device, a display, a communication interface, sensors, and power management units. The processor, the memory, the input/output (I/O) device, the communication interface, and the sensors may be connected to one another through a system bus. The processor may include a single processor having at least one core or multi processors each having at least one core. The watch body 11 may be embodied by the electronic device 100 illustrated in FIG. 1.

The processor may be embodied so that a user accepts, receives, translates and processes an audio frequency command together with an input/output device. For example, an audio codec may be used. The processor may execute instructions of an operating system OS or may execute various applications. The processor may control a command interaction between device constituents and communications of the input/output (I/O) device. For example, the OS, although it is not limited, may be a Linux Android, an Android Wear, or the like.

The memory may include at least one different kind of memory. For example, the memory may be a RAM (e.g., DRAM, SRAM), a ROM, a cache, a virtual microdrive, hard disks, micro SD cards and flash memories.

The input/output (I/O) device is a set of constituents that receive information and output information. For example, constituents constituting an input/output (I/O) device that receives data, outputs data or processes data may include a microphone, a camera, messaging and a speaker. The input/output device may further include an audio chip, a display controller and a touch screen controller.

A communication interface may include constituents supporting unidirectional or bi-directional wireless communications and may include a wireless network interface controller (or, similar constituents) for a wireless communication with respect to some embodiments, a wired interface of other embodiments, or a network of multiple interfaces. The communication interface exists to remotely receive data by priority. Herein, the data is streaming data being displayed on a display or being updated However, the communication interface may provide a voice transmission except data selectively being transmitted.

The communication interface may support radio frequency (RF) communications. Examples of a wireless communication may include Bluetooth Low Energy (BLE), wireless local area network (WLAN), worldwide interoperability for microwave access (WiMAX), passive radio frequency identification (RFID), network adapters and modems. However, examples of a wireless communication may also include a wide area network (WAN) interface, Wi-Fi, wireless personal area network (WPAN), multi homed networks, or a cellular network (e.g., 3G, 4G, 5G or long term evolution (LTE). The remaining wireless options may include an ultra wide band (UWB) and an infrared. The communication interface may also include different kinds of communications other than wireless, for example, a serial communication through contacts and/or USB communication. For example, a USB of a micro USB type, a flash drive, or different wired connection may be used together with the communication interface.

A display may be integrated into the watch body 11. The display may exist outside the watch body 11. The display may have a flat shape or a curved shape. Herein, the curved shape means that a curvature exists on a part (e.g., wrist, ankle head, etc.) of the body where a wearable sensor platform is located.

The display may include a touch screen or a gesture being controlled. The display may include an organic light emitting diode (OLED) display, a thin film transistor (TFT) LCD, or proper display technologies. The display may include an active-matrix. For example, the display may be an active-matrix organic light-emitting diode (AMOLED) display or a super LCD (SLCD). The display may be three-dimensional or may be flexible. The sensors may include microelectromechanical system (MEMS) sensors. These sensors may include accelerometer/gyroscope and a thermometer.

The power supply management unit may be connected to a power supply source and may include microcontrollers that communicate with and/or control power supply functions in a part of the watch body 11. The power supply management unit communicates with a processor and adjusts a power management. The power supply management unit determines whether a period of time has passed, and subsequently performs a second charge.

The power supply source may be a permanent or detachable battery, a fuel cell or a photo voltage cell, or the like. The battery may be disposable. The power supply source may include a rechargeable lithium ion battery or the like. The power supply management unit may include a voltage controller and a charge controller recharging a battery. At least one solar cell may be used as a power supply source. The power supply source may be charged by an AC/DC power supply. The power supply source may be charged by contact charge or contactless charge. The power supply management unit may control a supply of battery power to a detachable sensor module through a power supply interface. The battery may be built in the watch body 11. The batter may exist outside the watch body 11.

As illustrated in FIG. 17, an appearance of the display of the watch body 11 may be embodied by a round type. That is, the watch body 11 may include a circular display panel. The may however be embodied as having different shapes, such as square for example.

The watch body 11 may have a battery (not shown) embedded therein for charging a power supply voltage by a wired charging method or a wireless charging method. The wireless charging method may be at least one of various wireless charging methods such as magnetic induction, magnetic resonance, non radial wireless charge, or the like. The battery may be embedded in the watch band 12.

The watch band 12 may include a health sensor 130 (refer to FIG. 1) that senses physiological data, that is health data from at least one user. For example, the health sensor may sense a heartbeat, oxygen concentration in a blood vessel, temperature, blood pressure, blood sugar, or body fat of a person wearing the wearable watch 10.

An electronic device according to embodiments of the inventive concept is a device for safely protecting secure information and privacy information of a user such as health data, payment data, or the like.

An electronic device according to embodiments of the inventive concept may provide enhanced security. To safely protect user information of the electronic device from malware, hacking, or the like, a ciphering operation needed to manage a key is performed in a tamper-proof secure element (SE). An authentication and key exchange, a secure channel encryption/decryption and a message authentication for setting a secure channel between a safe SE in hardware and a secure OS (e.g., TEE) are provided.

An electronic device according to embodiments of the inventive concept provides a secure protocol between a TEE and an SE without near field communication (NFC). Embodiments of the inventive concept may process a strong secure requirement of various applications through a general protocol for a secure communication between a TEE of an application processor (AP) and an SE. Because functions of an authority acquisition for an SE use secret information protection, a secure firmware update is accessible only through a secure protocol between a TEE and an SE safely designed. The inventive concept may design a secure protocol to be compatible with a global platform SE access control, a secure channel protocol 03, or the like.

Embodiments of the inventive concept provide superior performance and improvement of a ciphering operation as compared to a Java Card OS on an embedded secure element (eSE) and a trust applet on a global platform layer.

As described above, an electronic device in accordance with exemplary embodiments of the inventive concept and a data transmission method thereof may secure a simple and safe data transmission channel by forming a secure channel by a secure protocol using a personal identification number between a trusted execution environment and a secure element.

The above description should be considered as illustrative and not limiting, and the appended claims should cover all such modifications, enhancements, and other embodiments, which fall within the true spirit and scope of the inventive concept. Thus, to the maximum extent allowed, the scope of the inventive concept should be determined by the broadest permissible interpretation of the following claims and their equivalents, and shall not be restricted or limited by the foregoing detailed description.

What is claimed is:

1. A data transmission method of an electronic device having a secure element comprising:
executing a trusted application on a trusted execution environment;
taking an ownership with respect to the secure element using a personal identification number (PIN) in the trusted execution environment;
collecting data related to personal information of a user;
after obtaining the ownership, encrypting the data in the secure element; and
outputting the encrypted data to an external server.

2. The data transmission method of claim 1, wherein the taking an ownership comprises:
generating ownership authentication data using the personal identification number;
encrypting the ownership authentication data in the trusted execution environment using a public key of the secure element;
requesting the ownership by transmitting the encrypted ownership authentication data to the secure element in the trusted execution environment;
decrypting the encrypted ownership authentication data by a private key of the secure element;
storing the decrypted ownership authentication data in the secure element;
generating and storing a storage root key corresponding to the user in the secure element; and
transmitting a response to the ownership request in the secure element using the trusted execution environment.

3. The data transmission method of claim 1, further comprising sharing a session key between the trusted execution environment and the secure element through an authentication and a key exchange scheme.

4. The data transmission method of claim 1, further comprising generating a key to be stored in the secure element, a key to be stored outside the secure element, and a key to be stored outside of the trusted execution environment.

5. The data transmission method of claim 1, further comprising loading a key stored in the secure element to a random access memory (RAM) of the secure element using the trusted execution environment, loading a decrypted key by using a storage root key into the trusted execution environment, or loading a decrypted key by using a session key into an outside of the trusted execution environment.

6. The data transmission method of claim 1, further comprising requesting storage of a key in the secure element using the trusted execution environment.

7. The data transmission method of claim 1, further comprising requesting removal of a key stored in the secure element using the trusted execution environment.

8. The data transmission method of claim 1, further comprising:
requesting a sign with respect to the data from the secure element using the trusted execution environment; and
generating a signature value by encrypting the data by using a private key of the secure element in response to the sign request.

9. The data transmission method of claim 8, further comprising:
requesting verification of the signature value with respect to the data to the secure element using the trusted execution environment; and
verifying the signature value using a public key of the secure element in the secure element.

10. The data transmission method of claim 1, further comprising:
requesting a hash-based message authentication code value with respect to the data to the secure element using the trusted execution environment; and
generating the hash-based message authentication code value with respect to the data using a hash-based message authentication code key in the secure element.

11. The data transmission method of claim 10, further comprising:
requesting verification of the hash-based message authentication code value with respect to the data using the trusted execution environment; and
verifying the hash-based message authentication code value using the hash-based message authentication code key in the secure element.

12. The data transmission method of claim 1, wherein the encrypting the data comprises:
transmitting the data and a ciphering algorithm to the secure element using the trusted execution environment; and
encrypting the data according to the type of the ciphering algorithm in the secure element.

13. The data transmission method of claim 14, further comprising:
requesting decryption of the encrypted health data to the secure element using the trusted execution environment; and
decrypting the encrypted health data according to the type of the ciphering algorithm in the secure element.

14. An electronic device comprising:
a sensor configured to sense data related to personal information of a user;
an application processor configured to include a rich execution environment executing at least one application, and a trusted execution environment that provides a secure level with respect to an attack from the rich execution environment and that executes a trusted application to collect the data from the sensor; and
a secure element configured to execute communication with the trusted execution environment by a secure protocol using a personal identification number of the user,
wherein the collected data is encrypted by the secure element, and the encrypted data is transmitted to an external server.

15. The electronic device of claim 15, wherein the sensor comprises a health sensor, and the collected data comprises detected body information of the user.

16. The electronic device of claim 14, configured as a watch wearable by the user.

17. An electronic device comprising:
a device body configured to input and display data; and
a band attached to the device body and having at least one sensor configured to sense data related to personal information of a user, the band configured to be wearable by the user,
the device body comprising
an application processor including a trusted execution environment configured to provide a secure level against unauthorized external access and to execute a trusted application to collect the data from the at least one sensor; and
a secure element configured to execute communication with the trusted execution environment by a secure protocol using a personal identification number of the user,
wherein the collected data is encrypted by the secure element, and the encrypted data is transmitted to an external server.

18. The electronic device of claim 17, wherein the personal information comprises health information of the user.

19. The electronic device of claim 17, wherein the device body is configured to transmit the encrypted data to the external server wirelessly.

20. The electronic device of claim 17, wherein the device body comprises a watch.
